(19) United States
(12) Patent Application Publication
(10) Pub. No.: US 2018/0170752 A1
(43) Pub. Date: Jun. 21, 2018

(54) IN-SITU GENERATION OF CHLORINE DIOXIDE USING METHANESULFONIC ACID FOR REMEDIATION OF SCALE AND SULFIDE

(71) Applicant: Baker Hughes, a GE company, LLC, HOUSTON, TX (US)

(72) Inventors: BRETT CHANDLER, CALGARY (CA); RONALD PLASIER, CALGARY (CA)

(73) Assignee: Baker Hughes, a GE company, LLC, HOUSTON, TX (US)

(21) Appl. No.: 15/737,112

(22) PCT Filed: Aug. 17, 2016
(86) PCT No.: PCT/US2016/047256

§ 371 Date: Dec. 15, 2017

Related U.S. Application Data
(60) Provisional application No. 62/206,018, filed on Aug. 17, 2015.

(51) Int. Cl. C01B 11/02; C09K 8/52; C09K 8/532; E21B 37/06

(52) U.S. Cl. CPC C01B 11/024; E21B 37/06; C09K 8/532; C09K 8/52

(57) ABSTRACT

Various methods are disclosed for pumping sodium chlorite with the simultaneous addition of methanesulfonic acid (MSA) in a conventional acid stimulation. This allows for the delayed generation of chlorine dioxide to address iron sulfide and polysulfides in combination with biofilms and carbonate scales.

### CROSS REFERENCE TO RELATED APPLICATIONS

This patent application claims the benefit, and priority benefit, of U.S. Provisional Patent Application Ser. No. 62/206,018, filed Aug. 17, 2015, the contents of which are incorporated by reference herein in their entirety.

### BACKGROUND

Chlorine dioxide has a highly selective chemistry that can be used for bacterial and biofilm control and removal of iron sulfides, polysulfides, mercaptans, and some polymers. These are common byproducts found in injection, production, and disposal wells.

As chlorine dioxide is not suitable for transport, it must be generated at location and is typically done using a three chemical addition. For remediation treatments, this adds extra cost and requires specialized equipment and operators. Standard remediation treatments currently utilize acid to target scale, but are less effective with different forms of iron sulfide.

Recently, the combination of acrolein and acid has shown to provide excellent results when both scale and sulfide are contributing to well performance issues. However, acrolein is a highly toxic chemical that requires special training to apply, transport, and store. Chlorine dioxide is another option that can achieve similar results to an acrolein treatment, and while much less toxic, is service intensive.

Improvements in this field of technology are desired.

### SUMMARY

According to the illustrative embodiments disclosed herein, various methods are disclosed for pumping sodium chlorite with the simultaneous addition of methanesulfonic acid (MSA) in a conventional acid stimulation. This allows for the delayed generation of chlorine dioxide to address iron sulfide and polysulfides in combination with biofilms and carbonate scales.

In certain illustrative embodiments, a method for generating chlorine dioxide is provided, whereby a chlorite is reacted with methanesulfonic acid within a treatment well and all or part of the chlorite is converted to chlorine dioxide in situ within the treatment well. In some aspects, the molar ratio of methanesulfonic acid to chlorite can be in the range of about 2-4:1. In some aspects, the treatment well can be an injection well, a production well or a disposal well. The concentration of chlorine dioxide can be no more than 3000 ppm within the treatment well.

In certain illustrative embodiments, a method for remediation within a treatment well is provided, whereby a chlorite is reacted with methanesulfonic acid within the treatment well, all or part of the chlorite is converted to chlorine dioxide in situ within the treatment well, and a remediation subject is treated with the chlorine dioxide within the treatment well. In some aspects, the remediation subject can be one or more of sulfide, biofilm, and scale deposits. The molar ratio of methanesulfonic acid to chlorite is in the range of about 2-4:1. In some aspects, the treatment well can be an injection well, a production well or a disposal well. The chlorite can be sodium chlorite. The concentration of chlorine dioxide can be no more than 3000 ppm within the treatment well.

The disclosed subject matter offers similar or better performance than acid+acrolein treatments, with a much wider margin of safety and simplified operations and logistics.

While certain preferred illustrative embodiments will be described herein, it will be understood that this description is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

The presently disclosed subject matter relates to in-situ wellbore generation of chlorine dioxide using synthetic and organic acids, for example, methanesulfonic acid (MSA), for remediation of scale and sulfide. The invention provides a possible solution to the negatives associated with using chlorine dioxide while creating a more efficient solution to address scale and sulfide related issues. The presently disclosed subject matter can be applied by a variety of equipment and personnel with the added benefit that both the chlorine dioxide and MSA are environmentally friendly, biodegradable, and safer to apply.

MSA is a colorless liquid with the chemical formula CH₃SO₃H. It is an alkylsulfonic acid and can be used as an acid catalyst in organic reactions because it is a non-volatile, strong acid that is soluble in organic solvents. MSA is convenient for industrial applications because it is a liquid at ambient temperature.

An equation for the reaction utilizing MSA is as follows:

5NaClO₂+4CH₃SO₃H→4ClO₂+4CH₃SO₃Na+NaCl+2H₂O

In the above reaction, sodium chlorite undergoes acidic decomposition into chlorine dioxide and, to a much lesser extent, chlorate. This process is dependent on temperature and pH. When acidified in the absence of oxidizable material, chlorite yields mainly chlorine dioxide in a pH range of 2-3. The decomposition of chlorite in an acid solution may produce both chlorine dioxide and chlorate. The rate of decomposition and reaction products is greatly influenced by experimental conditions, especially pH and the presence of chloride. The decomposition of sodium chlorite under weekly acidic conditions (pH of >3 and <5) will predominantly produce chlorine dioxide, a weakly acidic chlorite solution with a ratio of chlorine dioxide formed to the chlorite consumed of 50%. Reaction rate will increase with decreasing pH and increasing chlorite concentration and temperature. Optimal conditions for chlorine dioxide generation by acidic decomposition of sodium chlorite utilizing synthetic and organic acids are lower pH, higher temperature and higher chlorite concentration.

The presently disclosed subject matter uses MSA, a C1 non-oxidizing acid, according to the above reaction to treat scale related issues in the well and near-wellbore. The MSA: (1) will not form emulsions or sludge related issues; (2) is non-reactive to chlorine dioxide; and (3) allows for the generation of ClO₂ when combined with a chlorite salt or solution thereof.

In certain illustrative embodiments, an excess of MSA is combined with a solution of sodium chlorite to reach a desired concentration of chlorine dioxide of no more than 3000 ppm after 100 minutes of time. The solutions can be pumped simultaneously through a standard TP pumper or coil unit and the well can be shut in to treat the desired interval. The chlorine dioxide produced by the combination of the MSA and chlorite can remove sulfide, biofilm, and scale deposits thus providing an effective remediation solution.

In certain illustrative embodiments, the presently disclosed subject matter can be used in situ for remediation of scale and sulfide in a treatment well. As used herein, the term “treatment well” includes injection, production, and disposal wells as well as other Class II wells that inject fluids associated with oil and natural gas production. The presently disclosed subject matter can also be used in other locations and circumstances such as, for example, other wells or near wellbores.

In an illustrative embodiment, a method for generating chlorine dioxide is provided wherein the method comprises reacting a chlorite with methanesulfonic acid within a treatment well and converting all or part of the chlorite to chlorine dioxide in situ within the treatment well. The molar ratio of methanesulfonic acid to chlorite is preferably in the range of about 2-4:1, and the treatment well can comprise an injection well, a production well or a disposal well.

In certain illustrative embodiments, the elevated temperature and pressures can generate the targeted chlorine dioxide product in greater concentration and efficiency. For example, conversion of chlorite into chlorine dioxide is a relatively slow kinetic process that can take up to 100 minutes at a pH of 2 and ambient conditions. The presently disclosed method can also be used in combination with common inhibitors and stabilizers in routine use.

The presently disclosed subject matter is a rapid and low cost remediation treatment that offer customers significant value compared to other more expensive options, and does so in a way that will minimize negative effects while providing a “green” treatment option. If viable, significant economic margins can be realized from this approach.

The presently disclosed subject matter is further described by the following prophetic example of experiments which are contemplated to demonstrate and evaluate the performance of the disclosed subject matter. All parameters and data are not to be construed to unduly limit the scope of the embodiments of the disclosed subject matter.

### Prophetic Example

In this prophetic example, different concentrations of methanesulfonic acid (MSA) (1-50% concentration (w/w)) are tested and mixed with sodium chlorite (1-25% concentration (w/w)) and the formation kinetics of chlorine dioxide is determined. A second set of tests is then performed to determine the effect of temperature on the rate of formation for these solutions. Finally, a test is performed to determine what effects that different sludge preventers and clay control agents will have on the formation and stability of the product.

It is expected that the greatest efficiency of chlorine dioxide generation will occur with an MSA acid concentration of 2-4:1 of MSA:chlorite. This is due to the fact that downhole conditions will consume a % of the acid due to the reactivity with a given formation. It is also expected that the rate of chlorine dioxide formation will accelerate with temperature and anticipated that each 10° C. that the temperature increases, the formation rate will double.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for generating chlorine dioxide, the method comprising:
reacting a chlorite with methanesulfonic acid within a treatment well; and
converting all or part of the chlorite to chlorine dioxide in situ within the treatment well.

2. The method of claim 1, wherein the molar ratio of methanesulfonic acid to chlorite is in the range of about 2-4:1.

3. The method of claim 1, wherein the treatment well comprises an injection well.

4. The method of claim 1, wherein the treatment well comprises a production well.

5. The method of claim 1, wherein the treatment well comprises a disposal well.

6. The method of claim 1, wherein the chlorite is sodium chlorite.

7. The method of claim 1, wherein the concentration of chlorine dioxide is no more than 3000 ppm within the treatment well.

8. A method for remediation within a treatment well, the method comprising:
reacting a chlorite with methanesulfonic acid within the treatment well;
converting all or part of the chlorite to chlorine dioxide in situ within the treatment well; and
treating a remediation subject with the chlorine dioxide within the treatment well.

9. The method of claim 8, wherein the remediation subject comprises one or more of sulfide, biofilm, and scale deposits.

10. The method of claim 8, wherein the molar ratio of methanesulfonic acid to chlorite is in the range of about 2-4:1.

11. The method of claim 8, wherein the treatment well comprises an injection well.

12. The method of claim 8, wherein the treatment well comprises a production well.

13. The method of claim 8, wherein the treatment well comprises a disposal well.

14. The method of claim 8, wherein the chlorite is sodium chlorite.

15. The method of claim 1, wherein the concentration of chlorine dioxide is no more than 3000 ppm within the treatment well.
